(19) United States
(12) Patent Application Publication
(10) Pub. No.: US 2013/0019186 A1
(43) Pub. Date: Jan. 17, 2013

(54) MANAGING PRIVACY PREFERENCES IN A WEB CONFERENCE

(71) Applicants: John M. Lance, Littleton, MA (US); Amy D. Travis, Arlington, MA (US); Anuphinh P. Wanderski, Durham, NC (US); Michael C. Wanderski, Durham, NC (US)

(72) Inventors: John M. Lance, Littleton, MA (US); Amy D. Travis, Arlington, MA (US); Anuphinh P. Wanderski, Durham, NC (US); Michael C. Wanderski, Durham, NC (US)

(73) Assignee: INTERNATIONAL BUSINESS MACHINES CORPORATION, Armonk, NY (US)

(21) Appl. No.: 13/181,966

(22) Filed: Jul. 13, 2011

(51) Int. Cl. G06F 3/00

(52) U.S. Cl. 715/753

(57) ABSTRACT

A method, system or computer usable program product for translating native application privacy preferences in a web conference including initiating the web conference between a first and a second user, sharing the display of the first user with the second user within the web conference to produce a shared display, wherein elements marked as private by an application resident on a first computer system of the first user are redacted in the shared display sent to the second user.

### BACKGROUND

1. Technical Field

The present invention relates generally to managing privacy preferences in a web conference, and in particular, to a computer implemented method for translating application privacy preferences among users within a web conference.

2. Description of Related Art

Web conferencing across a network in a web conference is a common application and is often combined with a teleconference or other type of verbal and/or visual communication session between multiple users. This allows a presenter to share content displayed in his or her computer display with other participants or attendees. That content may include a spreadsheet, document, presentation material, web page, a cursor for pointing, or other content the presenter may display on his or her computer display.

The rendered content displayed on the presenter's computer display is then compressed and possibly encrypted for transmission across a network such as the internet to the computers of each attendee. Each attendee's computer then decompresses, decrypts and displays that same content on a computer display for that attendee to view. As a result, each attendee is viewing the same information as the presenter, thereby allowing the presenter to discuss that content with the attendees in the communication session.

The presenter is also able to modify the content displayed on the presenter's display, such as by scrolling through a document within a window, and the resulting rendered changes are then transmitted across the network to each attendee to view the same changes in content. This allows a presenter to transmit and control what is viewed by the attendees. This also allows the presenter to further discuss what is being displayed with the attendees in the communication session.

The presenter may share the entire content of the presenter's computer display, which may include windows displaying content from multiple applications. As an alternative, the presenter may only share the content of a single window rendered on the presenter's computer display. In either case, it is the rendered content on the presenter's display that is shared with the attendees during the communication session, thereby allowing the presenter to manage the information being shared.

### SUMMARY

The illustrative embodiments provide a method, system, and computer usable program product for translating native application privacy preferences in a web conference including initiating the web conference between a first and a second user, sharing the display of the first user with the second user within the web conference to produce a shared display, wherein elements marked as private by an application resident on a first computer system of the first user are redacted in the shared display sent to the second user.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 depicts a block diagram of a network of data processing systems in which various embodiments may be implemented;

FIG. 2 depicts a block diagram of a data processing system in which various embodiments may be implemented;

FIG. 3 depicts a diagram of information which may be displayed on a presenter's computer display in which various embodiments may be implemented;

FIG. 4 depicts a diagram of information from FIG. 3 which may be displayed on an attendee's computer display in which various embodiments may be implemented;

FIG. 5 depicts a block diagram of multiple computer systems sharing a web conference in which various embodiments may be implemented;

FIG. 6 depicts a window or pop-up box which allows a presenter to manage the privacy controls implemented by the web conference software in which various embodiments may be implemented;

FIG. 7 depicts a flowchart of the operation of the web conference software in which a first embodiment may be implemented; and

FIG. 8 depicts a flowchart of the operation of the web conference software in which a second embodiment may be implemented.

### DETAILED DESCRIPTION

Steps may be taken to prevent the display or presentation of certain information rendered on a presenter's display. These steps may be taken as will be explained with reference to the various embodiments below.

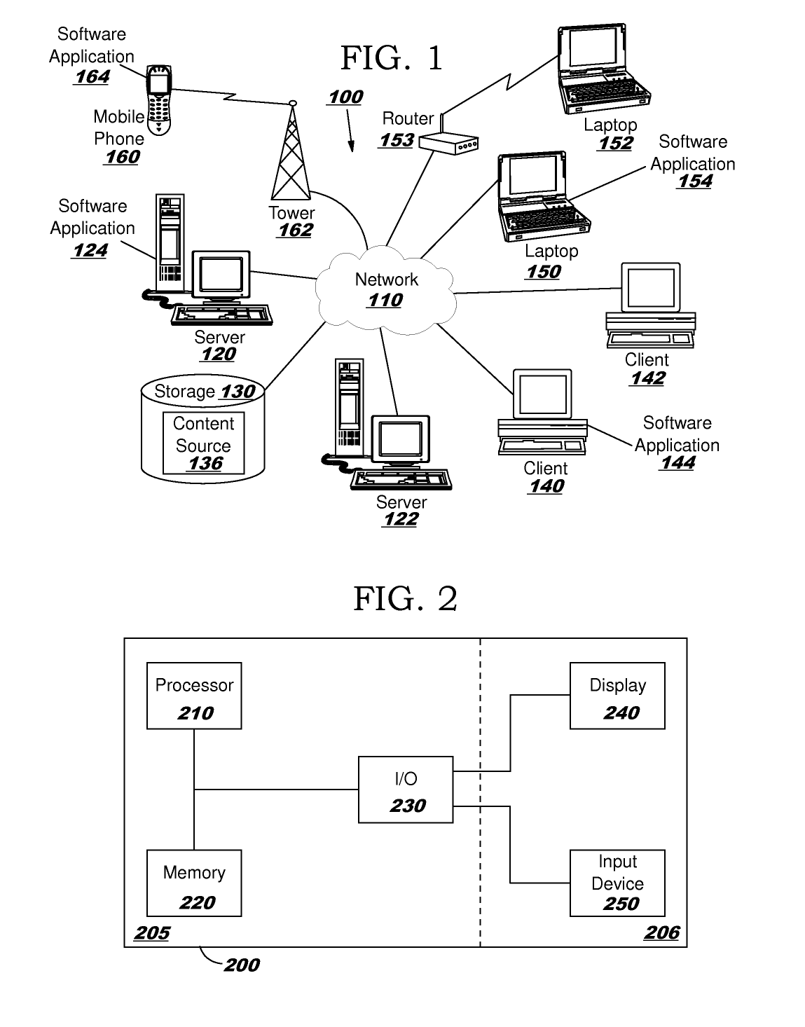

FIG. 1 depicts a pictorial representation of a network of data processing systems in which various embodiments may be implemented. Data processing environment 100 is a network of data processing systems also known as computers or computer devices in which the embodiments may be implemented. Software applications may execute on any computer or other type of data processing system in data processing environment 100. Data processing environment 100 includes network 110. Network 110 is the medium used to provide communications links between various devices and computers connected together within data processing environment 100. Network 110 may include connections such as wire, wireless communication links, or fiber optic cables.

Servers 120 and 122 and clients 140 and 142 are coupled to network 110 along with storage unit 130. In addition, laptops 150 and 152 are coupled to network 110 including wirelessly through a network router 153. A mobile phone 160 is also coupled to network 110 through a mobile phone tower 162. Data processing systems, such as server 120 and 122, client 140 and 142, laptops 150 and 152, and mobile phone 160, may contain data and may have software applications including software tools executing thereon. Other types of data processing systems such as personal digital assistants (PDAs), smartphones, tablets and netbooks may be coupled to network 110.

Server 120 may include software application 124 such as for managing a web conference for the various computer devices or other software applications in accordance with embodiments described herein. Storage 130 may contain a content source such as a spreadsheet, document, presentation, web page (or content from a web server) or other content for sharing among various computer or other data processing devices. Client 140 may include software application 144. Laptop 150 and mobile phone 160 may also include software applications 154 and 164. Other types of data processing systems coupled to network 110 may also include software applications and web conference share applications as well as other security utilities. Software applications could include a web browser, email, or other software application that can process a web page, email, or other type of information to be processed.

Servers 120 and 122, storage unit 130, clients 140 and 142, laptops 150 and 152, and mobile phone 160 and other data processing devices may couple to network 102 using wired connections, wireless communication protocols, or other suitable data connectivity. Clients 140 and 142 may be, for example, personal computers or network computers.

In the depicted example, server 120 may provide data, such as boot files, operating system images, and applications to clients 140 and 142 and laptop 150. Clients 140 and 142 and laptop 150 may be clients to server 120 in this example. Clients 140 and 142, laptops 150 and 152, mobile phone 160, or some combination thereof, may include their own data, boot files, operating system images, and applications. Data processing environment 100 may include additional servers, clients, and other devices that are not shown.

In the depicted example, data processing environment 100 may be the Internet. Network 110 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

FIG. 2 depicts a block diagram of a data processing system in which various embodiments may be implemented. Data processing system 200 is an example of a computer device, such as server 120, client 140, laptop 150 or mobile phone 160 in FIG. 1, in which computer usable program code or instructions implementing the processes may be located for the illustrative embodiments.

In the depicted example, data processing system 200 includes a CPU or central processing unit 210 which may contain one or more processors and may be implemented using one or more heterogeneous processor systems including a graphics processor. The depicted example also includes a memory 220 which may be used for storing instructions and data to be processed by CPU 210. Memory 220 may include a main memory composed of random access memory (RAM), read only memory (ROM), or other types of storage devices. Memory 210 could also include secondary storage devices such as a hard disk drive, DVD drive or other devices which may be internal or external to data processing system 200. An input output device (I/O) 230 is also shown in the depicted example for managing communications with various input devices and output devices. However, other examples could use the CPU to communicate directly with various input or output devices or use separate input and output controllers.

In the depicted example, a computer display 240 is shown for the data processing system to communicate with a user or another data processing system. Other types of output devices may be used such as an audio device. An input device 250 is also shown which may be a keyboard, mouse, a touch sensitive display, or other types of input devices.

Data processing system 200 is shown with an internal section 205 and an external section 206. Often input and output devices may be physically separate from but connected to the CPU and memory. However, that is often not the case with portable devices such as mobile phones.

An operating system may run on processor 210. The operating system coordinates and provides control of various components within data processing system 200 in FIG. 2. The operating system may be a commercially available operating system. An object oriented programming system may run in conjunction with the operating system and provides calls to the operating system from programs or applications executing on data processing system 200. Instructions for the operating system, the object-oriented programming system, and applications or programs may be located on secondary storage devices such a hard drive, and may be loaded into RAM for execution by processing unit 210.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1 and 2. In addition, the processes of the embodiments may be applied to a multiprocessor data processing system.

The depicted examples in FIGS. 1-2 and above-described examples are not meant to imply architectural limitations. For example, data processing system 200 may also be a mobile phone 160, tablet computer, laptop computer, or telephone device.

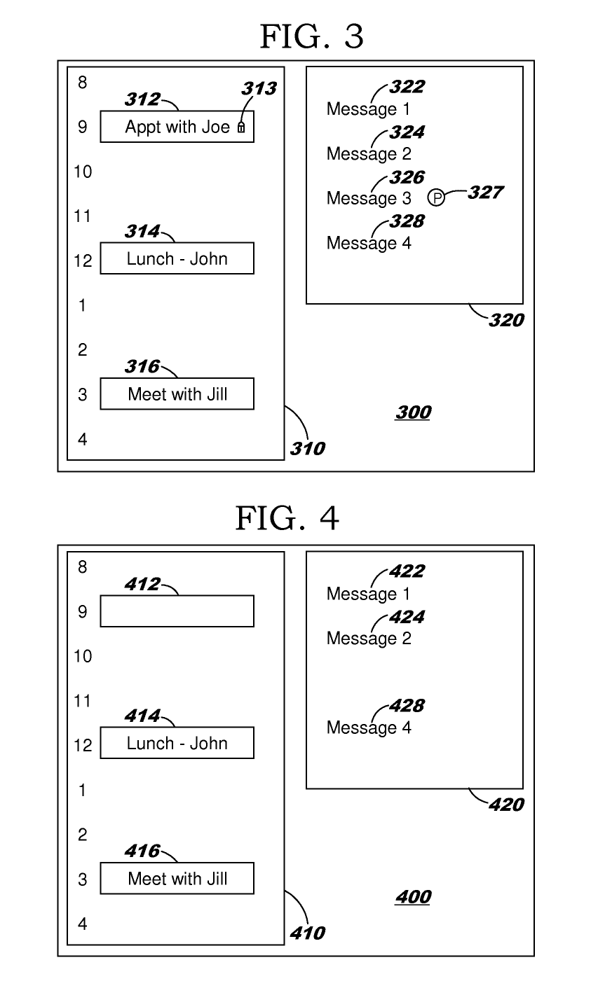

FIG. 3 depicts a diagram of information which may be displayed on a presenter's computer display in which various embodiments may be implemented. A screen or window 300 is shown displaying information which may be generated by one or more applications from one or more content sources such as a spreadsheet, document, database, web page (or content from a web server) or any other type of content.

A first window 310 is of a calendar such as may be utilized in various email applications. Three different appointments are shown as elements 312, 314 and 316. A second window 320 contains elements 322, 324, 326 and 328 which may be cells of a spreadsheet, paragraphs of a document, parts of a presentation, parts of a web page, etc. Alternatively, these elements may also be grouped in multiple windows. For example, Message 1 and 2 may be information in a first window from a first application such as a spreadsheet and Message 3 and 4 may be information in a second window from a second application such as a document.

Certain information, referred to herein as private elements, in each content source may be identified as sensitive, confidential, secure, or otherwise undesirable to display freely, such as in a web conference. Those private elements may be highlighted or otherwise indicated as such by an owner or other authorized person or entity. The owner may be the presenter or may be another person or entity managing that content source. Once highlighted or otherwise indicated, additional data may be specified such as the type of privacy for that information. While this information is available for the presenter to consider, the presenter may make select whether to share certain private elements with attendees in a web conference.

In this example, elements 312 and 326 may be indicated as private elements and only displayed to users with the necessary authorization or permissions. As a result, flags 313 and 327 are displayed by the software applications managing these elements. Different applications may use different types of flags to indicate privacy such as a lock for confidential or a “p” in a circle to indicate private. Flags 313 and 327 may also be added during the screen sharing process as toggles to allow the presenter to unlock the respective elements 312 and 326.

FIG. 4 depicts a diagram of information from FIG. 3 which may be displayed on an attendee's computer display in which various embodiments may be implemented. If the attendee is not authorized such as by the presenter, then the elements marked as private may not be displayed on the attendee's computer display 400. Elements 414, 416, 422, 424 and 428 corresponding to elements 314, 316, 322, 324 and 328 are displayed on the attendee's computer display. However, there are no elements shown corresponding to elements 312 and 326 of FIG. 3. Instead, a white out, blacked out, blurred, obscured, or otherwise redacted image is provided

A second attendee may have the necessary authorization or permission from the presenter to view all information from the content source or sources and will view the same private elements as shown in FIG. 3. A third attendee may have the necessary access rights or permission from the presenter to view some of the private elements from the content source such as element 312. As a result, element 312 may be displayed on the third attendee's computer display, but not element 327

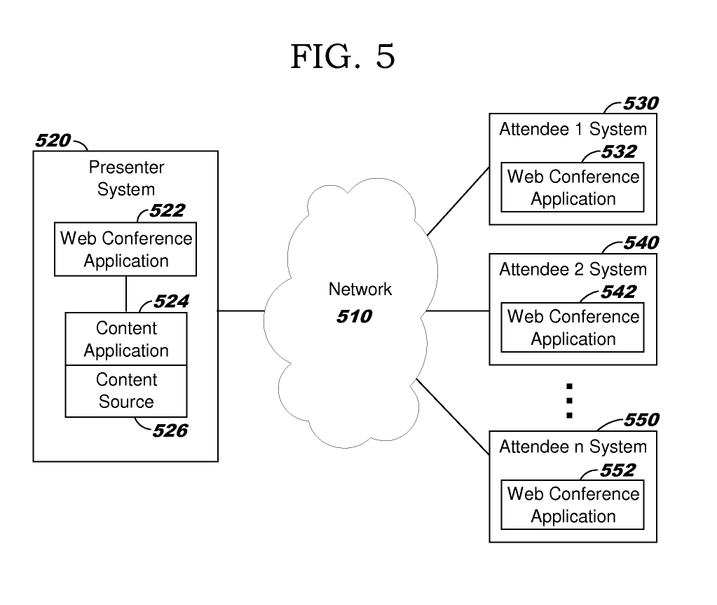

FIG. 5 depicts a block diagram of multiple computer systems sharing a web conference in which various embodiments may be implemented. A network 510 is utilized to interconnect several computer systems. The network may be the internet but could be any type of network where computer display information may be shared.

A presenter system 520 is shown interconnected across the network with multiple attendee systems 530, 540 and 550. Additional attendee systems may be interconnected as well. Each system is a data processing system and may be a computer, a cell phone, or other type of data processing system.

Presenter system 520 includes a web conference application 522, a content application 524 and a content source 526. The content source may be a document, spreadsheet, database, web page or other type of information which may be rendered in a presenter's computer display by a content application 524.

Several types of content applications may be utilized to provide content for a presenter's display. A first type is a scripting, declarative or interpreted language which utilizes a commonly known programming language distinct from the core code of an application and may be accessible by the end user. These declarative language applications can introspect or otherwise be queried by an application via script or similar technologies. A second type is a commonly known browser or web based application interface such as HTML, also accessible by the end user, which can also introspect or otherwise be queried by an application via script, microformats, etc. A third type is a legacy application interface which may be composed of native or core user interface toolkits, widgets or other proprietary technologies. The third type may also be queried by an event proxy service or by using user interface toolkits provided by the software application. The fourth type is all other types of software applications that are typically proprietary and not easily accessed or queried by other software applications. The first three types of content applications may be referred to collectively herein as declarative language applications, web based applications or native OS toolkits. These first three types of content applications may be queried or otherwise examined to identify and determine the location of private elements displayed by those content applications. The type of content application may affect the embodiment utilized as described below.

Web conference application 522 is utilized to share the displayed contents of the presenter's system with the various attendee systems. In an alternative embodiment, a proxying agent, application plug-in or other software tool may be utilized with the web conference software to implement various functions described below such as searching for private elements within the content source and modifying the content transmitted to the attendees in accordance with the instructions of the presenter. The web conference application or other software tool may determine which content applications are running and displaying data on a display by inquiries through the operating system. The operating system may provide handles of elements belonging to these content applications. The presenter may also manually select which content applications should be queried or otherwise interfaced with to identify any private elements being displayed by those content applications.

Attendee 1 system 530, attendee 2 system 540, and attendee n system 550 each include a web conference application 532, 542 and 552 respectively. Each attendee's web conference application may not need all the functionality of the presenter web conference application 522. That is, each attendee web conference application may contain only enough programming to display information from the presenter web conference application in accordance with the various embodiments. The attendee web conference applications may be downloaded onto the attendee systems as the web conference process is initiated.

These systems could also be organized in a client server or cloud configuration where the content source and or web conference applications may be located on a server. Other configurations may also be implemented as would be recognized by one skilled in the art.

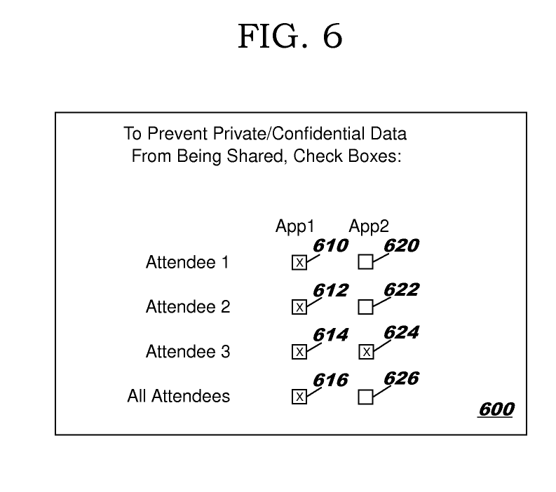

FIG. 6 depicts a window or pop-up box which allows a presenter to manage the privacy controls implemented by the web conference software in which various embodiments may be implemented. This pop-up box could be shown on the presenter's display after the attendees have connected to the web conference session, but before any screen content is shared with the attendees. In this example, there is a row for each attendee connecting to the web conference session and a column for each content application displaying information on the presenter's computer display or otherwise active on the presenter's data processing system.

The presenter may then select which attendees may not view private elements by selecting boxes. For example, the presenter may select which attendees may not view App 1 private elements by selecting boxes 610, 612 and 614. The presenter also has the options to just select the all attendees box 616. In addition, the presenter may select which attendees may not view App 2 private elements by selecting boxes 620, 622 and 624 or the all attendees box 626. In this example, all attendees may not view private elements from App 1 and Attendee 3 may not view private elements from App 2. The presenter may also be provided the opportunity for finer grain control such as whether to share certain displayed elements by element rather than by application.

Alternative embodiments may use buttons or other methods of selecting choices. In addition, the choices could be organized in alternative forms such as by attendee domain, attendee position within a company, as well as by class of application. Other methods of indicating choices may also be used. In addition, the presenter may select certain content applications which may not be displayed on attendee's computer displays (e.g. blacking out the entire content of a certain content application on attendee's displays). The presenter may also select content applications for the web application to inquire for preexisting privacy setting within those applications. The presenter may also manually select certain areas on a display for sharing and other areas for not sharing.

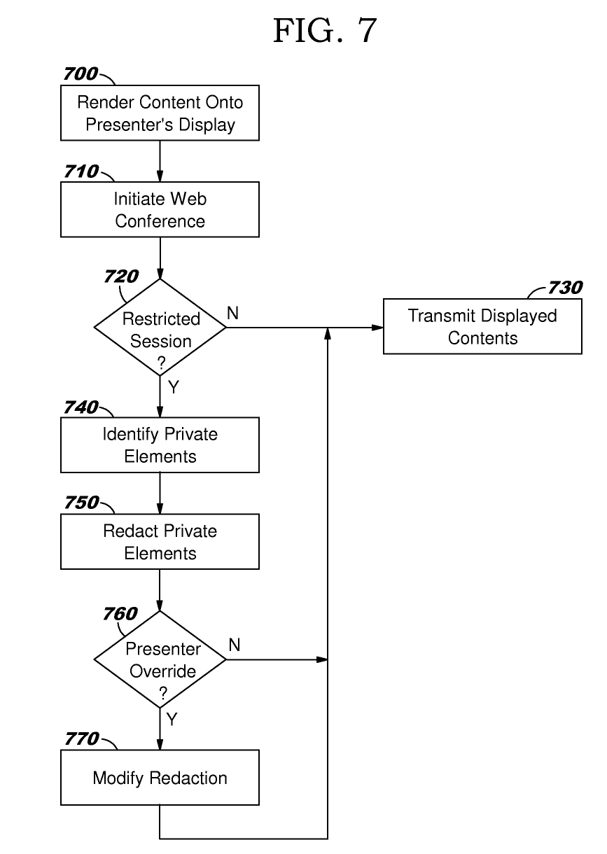

FIG. 7 depicts a flowchart of the operation of the web conference software in which a first embodiment may be implemented. This embodiment may be most efficiently utilized when one or more software applications utilize declarative language applications, web based applications or native OS toolkits. In this embodiment, the content application and source used to generate a bitmap of the presenter's display may be scanned for certain private elements.

In a first step 700, the presenter's content applications render content onto the presenter's display. The presenter then initiates the web conference session in step 710 whereby attendees may join the web conference. In step 720, the web conference software inquires or determines whether the session is restricted in any manner, such as with the pop-up box of FIG. 6. If not, then in step 730, the session proceeds by sharing the current bitmap or content source with the attendees. If yes in step 720, then processing proceeds to step 740.

In step 740, the content application and source used to generate the presenter's display is accessed and searched for private elements. That is, the content application(s) being displayed are examined to determine whether there are any privacy preferences native to those application(s). For example, appointment 312 and message 3 326 shown in FIG. 3 may be identified as private. This identification may be performed by inquiries to the operating system or by the presenter manually identifying the content applications or private elements therein. Once identified, in step 750 the private elements are redacted in accordance with the instructions of the presenter in step 720 above. The modification can be by changing the pixels to black, blurring the pixels by averaging pixel values by adjoining pixel values, or other similar redaction techniques.

In step 760, it is determined whether the presenter indicates whether any such private elements should be disclosed. This could be accomplished by the presenter clicking on a flag or toggle such as a lock indicating that the material should be unlocked or otherwise made available to the attendees. If no, then processing continues to step 730. If yes, then the redaction is modified accordingly in step 770. This may be accomplished without affecting the underlying indications of privacy in the content source. Steps 760 and 770 may be repeated each time the presenter indicates an override of a private setting. The presenter may also be queried whether he or she wants to redact any sections not identified by the above process. Processing then continues to step 730 where the now redacted display is sent to the attendees for rendering on their displays.

The above processes from steps 720 to 770 each time the presenter modifies the content displayed on the presenter's display. As a result, any new information being displayed on the presenter's display will by checked for private elements before that information is shared with the attendees.

The presenter may also be given the opportunity to select which attendees may view or not view the redacted information. This selection could be performed for each piece of redacted information. Although the above was described with reference to a single application, it could also be applied to multiple applications and multiple content sources displayed on a presenter's display by repeating steps 720 through 770 for each application.

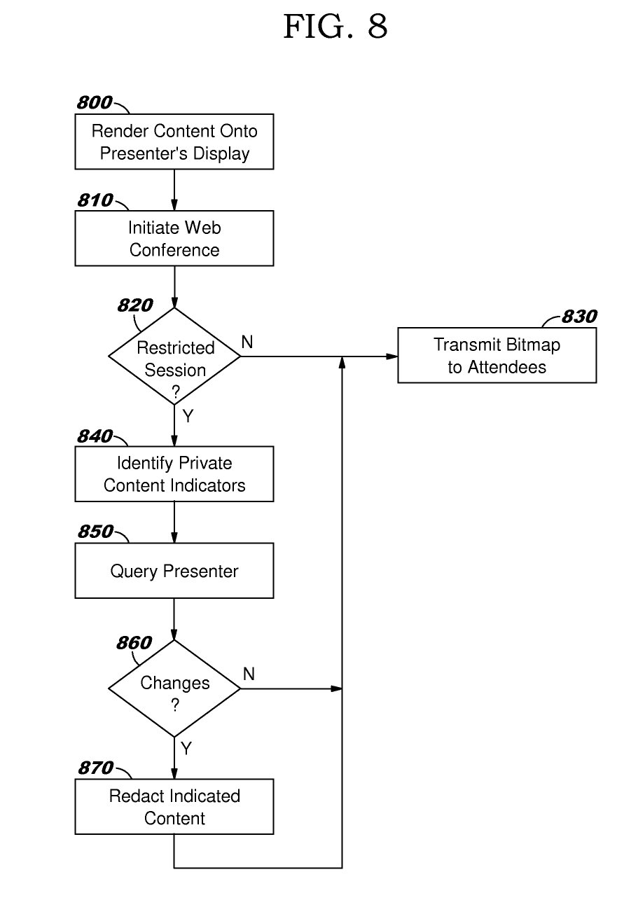

FIG. 8 depicts a flowchart of the operation of the web conference software in which a second embodiment may be implemented. This embodiment may be used when one or more software applications utilize proprietary technologies or other interfaces that do not allow the above first embodiment to be implemented efficiently. In this embodiment, the bitmap of the presenter's display may be scanned for certain patterns or language indicating that information displayed may be private.

In a first step 800, the presenter's software applications render content onto the presenter's display. The presenter then initiates the web conference session in step 810 whereby attendees may join the web conference. In step 820, the web conference software inquires or determines whether the session is restricted in any manner, such as with the pop-up box of FIG. 6. If not, then in step 830, the session proceeds by sharing the current bitmap with the attendees. If yes in step 820, then processing proceeds to step 840.

In step 840, the bitmap of the presenter's display is accessed and searched for identifying flags or language. That is, the application(s) being displayed are examined to determine whether there are any privacy preferences native to those application(s). For example, the lock flag 313 and P circle flag 327 shown in FIG. 3 may be identified as private. In addition, any words such as confidential or private may also be identified. Once identified, they are then indicated as such to the presenter in step 850 with a query asking what portion of the screen, if any, is private around the indicted area. This may be accomplished with the presenter user a cursor and mouse to indicate an area of redaction. The presenter may also be given an opportunity to override the redaction and allow the attendees to view the material. This could be accomplished by the presenter clicking on a flag or toggle such as a lock indicating that the material should be unlocked or otherwise made available to the attendees.

In step 860, it is determined whether the presenter indicated any private area to be redacted. If no, the processing continues to step 830. If yes, then the indicated section of pixels is modified. The modification can be by changing the pixels to black, blurring the pixels by averaging pixel values by adjoining pixel values, or other similar redaction techniques. Steps 850 through 870 may be repeated for each area identified as private. The presenter may also be queried whether he or she wants to redact any sections not identified by the above process. Processing then continues to step 830 where the now redacted bitmap is sent to the attendees for rendering on their displays.

The above processes from steps 820 to 870 each time the presenter modifies the content displayed on the presenter's display. As a result, any new information being displayed on the presenter's display will by checked for private elements before that information is shared with the attendees. The presenter may also be given the opportunity to select which attendees may view or not view the newly identified private elements. This selection could be performed for each newly identified private element. Although the above was described with reference to a single application, it could also be applied to multiple applications and multiple content sources displayed on a presenter's display by repeating steps 820 through 870 for each application.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as web conference applications or plug-ins. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of translating native application privacy preferences in a web conference comprising:
initiating the web conference between a first and a second user;
sharing the display of the first user with the second user within the web conference to produce a shared display, wherein elements marked as private by an application resident on a first computer system of the first user are redacted in the shared display sent to the second user.

2. The method of claim 1 wherein elements marked as private by the application are displayed on the display of the first user.

3. The method of claim 2 wherein a toggle in the user interface displayed by the first computer system is used to designate items as private.

4. The method of claim 1 wherein a third user is joined to the web conference, wherein the display of the first user is used to produce a second shared display, wherein at least one of the elements marked as private by an application resident on a first computer system of the first user are sent in the second shared display sent to the third user.

5. The method of claim 4 wherein the first user designates the at least one of the elements sent in the second shared display to the third user.

6. The method of claim 5 further comprising providing a menu to the first user for selecting elements to be marked as private.

7. The method of claim 6 wherein the menu further allows the first user to select whether the second or third user may view selected private elements.

8. The method of claim 1 wherein elements marked as private by the application are displayed on the display of the first user.

9. A computer usable program product comprising a computer usable storage medium including computer usable code for use in translating native application privacy preferences in a web conference, the computer usable program product comprising code for performing the steps of:
initiating the web conference between a first and a second user;
sharing the display of the first user with the second user within the web conference to produce a shared display, wherein elements marked as private by an application resident on a first computer system of the first user are redacted in the shared display sent to the second user.

10. The computer usable program product of claim 9 wherein elements marked as private by the application are displayed on the display of the first user.

11. The computer usable program product of claim 10 wherein a toggle in the user interface displayed by the first computer system is used to designate items as private.

12. The computer usable program product of claim 9 wherein a third user is joined to the web conference, wherein the display of the first user is used to produce a second shared display, wherein at least one of the elements marked as private by an application resident on a first computer system of the first user are sent in the second shared display sent to the third user.

13. The computer usable program product of claim 12 wherein the first user designates the at least one of the elements sent in the second shared display to the third user.

14. The computer usable program product of claim 13 further comprising code for performing the step of providing a menu to the first user for selecting elements to be marked as private.

15. The computer usable program product of claim 9, wherein the product is stored in a computer readable storage medium in a data processing system, and wherein the instructions were downloaded over a network from a remote data processing system.

16. The computer usable program product of claim 9, wherein the product is stored in a computer readable storage medium in a server data processing system, and wherein the instructions are downloaded over a network to a remote data processing system for use in a computer readable storage medium with the remote system.

17. A data processing system for translating native application privacy preferences in a web conference, the data processing system comprising:
a processor; and
a memory storing program instructions which when executed by the processor execute the steps of:
initiating the web conference between a first and a second user;
sharing the display of the first user with the second user within the web conference to produce a shared display, wherein elements marked as private by an application resident on a first computer system of the first user are redacted in the shared display sent to the second user.

18. The data processing system of claim 15 wherein elements marked as private by the application are displayed on the display of the first user.

19. The data processing system of claim 16 wherein a toggle in the user interface displayed by the first computer system is used to designate items as private.

20. The data processing system of claim 15 wherein a third user is joined to the web conference, wherein the display of the first user is used to produce a second shared display, wherein at least one of the elements marked as private by an application resident on a first computer system of the first user are sent in the second shared display sent to the third user.
